(19) United States
(12) Patent Application Publication
(10) Pub. No.: US 2003/0186095 A1
(43) Pub. Date: Oct. 2, 2003

(54) Lithium secondary battery

(75) Inventors: Eiji Okutani, Itano-gun (JP); Yoshikumi Miyamoto, Kyoto-shi (JP); Kazuyasu Fujiwara, Itano-gun (JP); Takuya Morimoto, Itano-gun (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/397,179

(22) Filed: Mar. 27, 2003

(30) Foreign Application Priority Data
Mar. 27, 2002 (JP) 2002-088324

(51) Int. Cl. H01M 8/24

(52) U.S. Cl. 429/18

(57) ABSTRACT

A lithium secondary battery of a structure insusceptible to an internal short circuit between a cathode and an anode is provided by adopting a configuration as would prevent occurrence of a short circuit between the cathode and anode even when the spiral electrode group is compression molded. The lithium secondary battery of the invention has a spiral electrode group “a” that is wound about such that its sectional shape is in the form of an ellipse having a pair of straight-line parts and curvilinear parts, comprising a cathode and an anode disposed so as to oppose the cathode with a separator sandwiched therebetween, inside a square-shaped outer case. Further, the cathode and anode, residing in the outermost peripheral part of the spiral electrode group “a”, are disposed such that the respective boundaries between parts of the respective current collectors thereof coated with corresponding compositions, and parts of the respective current collectors thereof uncoated with the corresponding compositions are disposed so as to reside within the curvilinear part of the spiral electrode group “a”. Accordingly, even if the spiral electrode group “a” is compression molded, a portion of the separator lying within the curvilinear part of the spiral electrode group “a” is subjected to minimal compression force, so that deterioration of insulation resistance does not occur, thereby preventing the occurrence of a short circuit between the cathode and the anode through the intermediation of the separator.

### FIELD OF THE INVENTION

The present invention relates to a lithium secondary battery incorporating an electrode group comprising a cathode made up of a cathode current collector coated with a cathode composition, and an anode made up of an anode current collector coated with an anode composition, disposed in such manner as to oppose the cathode with a separator sandwiched therebetween, and in particular, to improvements of the lithium secondary battery by rendering the structure of the electrode group insusceptible to an internal short circuit occurring between the cathode and the anode.

### BACKGROUND OF THE INVENTION

There has been widespread use of a lithium secondary battery small in size and light in weight but having a large capacity, suitable for use in portable electronic and communication equipment such as a small size video camera, mobile phone, note PC, and so forth, making use of graphite as an anode active material capable of storing and releasing lithium ions, and a lithium-containing transition metal oxide such as lithium-containing cobalt oxide (LiCoO₂), lithium-containing manganese oxide (LiMn₂O₄), etc., as a cathode active material.

The lithium secondary battery utilized for most equipment is housed in an enclosed space in the shape of a square flat box-like shape, and fabricated by housing power generation elements in a square-shaped outer case. Such a square-shaped battery is commonly fabricated according to the following procedure.

More specifically, in the first step, a cathode plate is fabricated by coating a cathode current collector with a cathode composition containing a cathode active material while an anode plate is fabricated by coating an anode current collector with an anode composition containing an anode active material. Thereafter, the cathode plate and the anode plate are disposed so as to oppose each other with a separator sandwiched therebetween, and are wound about in spiral form, thereby forming a spiral electrode group. The spiral electrode group is then compression molded into a spiral electrode group in the sectional shape of an ellipse (having a pair of straight-line parts and curvilinear parts). The spiral electrode group in the sectional shape of an ellipse is housed in a square-shaped outer case, and a nonaqueous electrolytic solution is injected thereto, thereby fabricating a square-shaped lithium secondary battery (refer to JP, H 9-171809, A, and JP, H 10-162792, A).

However, a problem has arisen in the process of fabricating the square shaped lithium secondary battery according to the procedure described above, in that an internal short circuit can suddenly occur therein at an incidence of 1 to 3 ppm. By disassembling one square-shaped lithium secondary battery to which an internal short circuit has occurred, investigation revealed that the short circuit occurred in the region X of the straight-line part of the outermost periphery of the spiral electrode group (on the spot where a portion of a cathode current collector 11, uncoated with a cathode composition, is opposed to a portion of an anode current collector 21, coated with an anode composition 22), and in the region Y of the other straight-line part thereof (on the spot where a portion of the cathode current collector 11 is opposed to a portion of the anode current collector 21), as shown in FIG. 2 (FIG. 2 shows only the neighborhood of the straight-line parts of the outermost peripheral part of the spiral electrode group in the sectional shape of an ellipse).

This is due to the fact that upon compression molding of the spiral electrode group when fabricating the spiral electrode group in the sectional shape of an ellipse having a pair of straight-line parts and curvilinear parts, portions of a separator 30 residing in the straight-line parts of the spiral electrode group in the sectional shape of an ellipse are subjected to compression force resulting in deterioration of insulation resistance thereof. Accordingly, as shown in FIG. 2, through the intermediation of the separator 30 with its insulation resistance lowered, an end 12b of a cathode composition layer 12 is opposed to an anode plate 20 (the region X in FIG. 2), and an end 22b of an anode composition layer 22 is opposed to the cathode current collector 11 (the region Y in FIG. 2). In such a case, if these opposed regions (the regions X, Y, in FIG. 2) are disposed so as to reside within the straight-line parts of the electrode group x, respectively, and foreign matter (that is, particulates of metal such as iron, nickel, etc.) is introduced into the region X or region Y within the respective straight-line parts of the electrode group x, the foreign matter breaks through the separator 30 in a state of lowered insulation resistance, whereupon a short circuit occurs on the spot where the cathode current collector 11 is opposed to the portion of the anode current collector 21, coated with the anode composition 22 (the region X) and the spot where the portion of the cathode current collector 11 is opposed to the portion of the anode current collector 21 (the region Y). Such an internal short circuit occurring through the intermediation of the current collectors will result in a large flow of current or lead to thermal damage.

### SUMMARY OF THE INVENTION

The present invention has been developed to eliminate the problem described above, and its object is to provide a lithium secondary battery of a structure insusceptible to internal short circuit during fabrication thereof by adopting a spiral electrode group comprising a cathode and an anode that are disposed in such manner as to prevent a short circuit therebetween upon compression molding of the spiral electrode group.

To that end, a lithium secondary battery according to the invention incorporates an electrode group in the sectional shape of an ellipse having a pair of straight-line parts and curvilinear parts, comprising a cathode and an anode wound about so as to oppose each other with a separator sandwiched therebetween, and the cathode and anode, located in the outermost peripheral part of such spiral electrode group are disposed such that the respective boundaries between parts of the cathode current collector and the anode current collector, coated with a cathode composition and an anode composition, respectively, and parts of the respective current collectors uncoated with corresponding compositions are disposed so as to reside within the respective curvilinear parts of the spiral electrode group.

If the cathode and anode are disposed such that the respective boundaries between parts of the cathode current collector and the anode current collector, coated with cathode composition and anode composition, respectively, and parts of the respective current collectors uncoated with corresponding compositions are disposed so as to reside within the respective curvilinear parts of the spiral electrode group, insulation resistance will not deteriorate even upon compression molding of the spiral electrode group for fabricating the spiral electrode group in the sectional shape of an ellipse having a pair of straight-line parts and curvilinear parts because a portion of the separator existing within the curvilinear parts of the spiral electrode group will be subjected to minimal compression force.

Consequently, if both the end portion of the cathode composition layer and the end portion of the anode composition layer reside within the curvilinear parts of the spiral electrode group, a short circuit will be prevented from occurring between the cathode current collector and the anode current collector extending from their respective ends, through the intermediation of the separator. Accordingly, even if foreign matter is introduced into the curvilinear parts of the spiral electrode group, the occurrence of a large flow of current or thermal damage resulting from a short circuit can be avoided because the separator, lying in the curvilinear parts, has excellent insulation resistance.

Now, where the outer case of the battery doubling as a cathode terminal and an exposed portion of the cathode current collector, neither face of which is coated with the cathode composition, is provided up to a predetermined length from the winding end of the cathode current collector to thereby serve as a region where the cathode current collector tab is installed, and a portion of the cathode current collector is coated with the cathode composition further from the exposed portion towards the starting part of winding such that the cathode composition layer lies upon only one face of a portion of the cathode current collector, the exposed portion of the cathode current collector can be placed in the outermost peripheral part of the spiral electrode group by wounding the cathode plate such that the side on which the cathode composition layer 12 lies on the portion of the cathode current collector, having the cathode composition layer residing on only one face thereof, confronts the inner side of the spiral electrode group. Consequently, the cathode composition in the outermost peripheral part of the spiral electrode group not contributing to battery reaction can be reduced, thereby enabling the cathode composition in portions of the spiral electrode group contributing to battery reaction to be increased, so that a lithium secondary battery with an enhanced discharge capacity can be obtained.

Further, in the case of the outer case of the battery doubling as an anode terminal, an exposed portion of the anode current collector, neither face of which is coated with anode composition is provided up to a predetermined length from the winding end of the anode current collector, and a portion of the anode current collector is coated with anode composition further from the exposed portion towards the starting part of winding, such that the anode composition layer lies upon only one face of a portion of the anode current collector, and the exposed portion of the anode current collector can preferably reside in the outermost peripheral part of the spiral electrode group.

### BRIEF DESCRIPTION OF THE DRAWINGS

FIG. 1 is a fragmentary sectional view schematically showing a part of an electrode group according to the embodiment of the invention; and

FIG. 2 is a fragmentary sectional view schematically showing a part of an electrode group according to the conventional example (comparative example).

### PREFERRED EMBODIMENT OF THE INVENTION

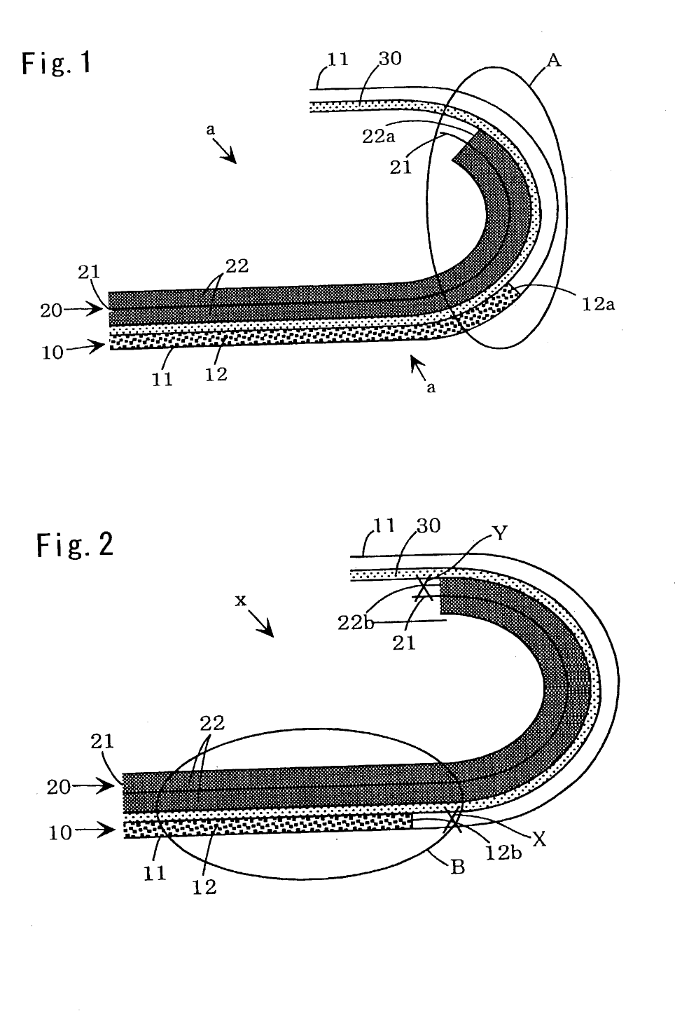

The embodiment of the invention is described hereinafter with reference to FIG. 1. However, it is to be understood that the scope of the invention is not limited to the embodiment in any way, and variations may be made as required without departing from the spirit or scope of the invention. FIG. 1 is a fragmentary sectional view schematically showing a part of an electrode group according to the embodiment of the invention, and FIG. 2 is a fragmentary sectional view schematically showing a part of an electrode group according to the conventional example (comparative example).

1. Fabrication of a Cathode

First, 85 parts by mass of lithium cobaltate (LiCoO₂) is mixed well with 5 parts by mass of artificial graphite powders and 5 parts by mass of carbon black, as an electroconductive agent, to form a cathode composition mixture. Thereafter, poly (vinylidene fluoride) as a binder, dissolved in N-methyl-2-pyrrolidone (NMP) in terms of a solid portion thereof, amounting to 5 parts by mass, is blended with the mixture, thereby forming a cathode composition slurry. Subsequently, both faces of a cathode current collector (an aluminum foil or aluminum alloy foil) 11 formed to a thickness of 20 μm is coated with the cathode composition slurry through the doctor blade method, thereby forming a cathode composition layer 12 on both faces of the cathode current collector 11. After drying, the cathode composition layers 12 are rolled to a predetermined thickness with a roller press, thereby fabricating a cathode plate 10.

In this case, the cathode current collector 11 is coated with the cathode composition slurry such that the cathode composition layer 12 lies on neither face of a portion of the cathode current collector 11, up to 20 mm from the winding end thereof (a portion thereof being uncoated with the cathode composition slurry), such portion being an exposed portion of the cathode current collector 11, and the cathode composition layer 12 lies on only one face of a portion of the cathode current collector 11 (where the cathode current collector 11 is exposed on one face of the cathode plate 10), up to 50 mm further from the exposed portion of the cathode current collector 11. When wounding the cathode plate 10, the same is wound about such that one side of the cathode composition layer 12 of a portion of the cathode current collector 11, having the cathode composition layer 12 lying on only one face thereof, confronts the inner side of a spiral electrode group as to permit the cathode current collector 11 to be placed in the outermost peripheral part of the spiral electrode group.

2. Fabrication of an Anode

Meanwhile, 95 parts by mass of natural graphite (with an Lc value of not less than 150 Å and a d value of not more than 3.38 Å) powders are mixed with poly (vinylidene fluoride) as a binder, dissolved in N-methyl-2-pyrrolidone (NMP) in terms of a solid portion thereof, amounting to 5 parts by mass, thereby forming an anode composition slurry. Subsequently, both faces of an anode current collector (a copper foil) 21 with a thickness of 18 μm are coated with the anode composition slurry through the doctor blade method, thereby forming an anode composition layer 22 on both faces of the anode current collector 21. After drying, the anode composition layers 22 are rolled to a predetermined thickness with a roller press, and an anode lead is welded to an end of the anode composition layer 22, thereby fabricating an anode plate 20.

3. Fabrication of the Spiral Electrode Group

### (1) EXAMPLE

Using the cathode plate 10 and the anode plate 20 fabricated in the manner described above, the cathode plate 10 and the anode plate 20 are disposed so as to oppose each other with a separator 30 made of polyethylene sandwiched therebetween, and subsequently wound about in a spiral form, thereby forming a spiral electrode group. In the fabrication of the spiral electrode group, the cathode plate 10 and the anode plate 20 are wound about such that the exposed portion of the cathode current collector 11 is disposed in the outermost peripheral part of the spiral electrode group.

Thereafter, the spiral electrode group is compression molded, thereby obtaining a spiral electrode group in the sectional shape of an ellipse (with a pair of straight-line parts and curvilinear parts). At this point, as shown in FIG. 1, the end 12a of the cathode composition layer 12 lying on only one face of a portion of the cathode current collector 11 is disposed so as to reside within the curvilinear part A of the spiral electrode group in the sectional shape of an ellipse while the end 22a of the anode composition layer 22 resting on the respective faces of the anode current collector 21 is disposed so as to also reside within the curvilinear part A of the ellipse. The spiral electrode group fabricated as above described is defined as electrode group “a” according to the embodiment of the invention.

### (2) COMPARATIVE EXAMPLE

Meanwhile, using a cathode plate 10 and an anode plate 20, fabricated in the manner described above, the cathode plate 10 and the anode plate 20 are disposed so as to oppose each other with a separator 30 made of polyethylene sandwiched therebetween, and are subsequently wound about in a spiral direction, thereby forming a spiral electrode group. In the fabrication of this kind of spiral electrode group as well, the cathode plate 10 and the anode plate 20 are wound about such that the exposed portion of the cathode current collector 11 is disposed in the outermost peripheral part of the spiral electrode group.

Thereafter, the spiral electrode group is compression molded, thereby obtaining a spiral electrode group in the sectional shape of an ellipse (with a pair of straight-line parts and curvilinear parts). At this point, as shown in FIG. 2, the end 12b of the cathode composition layer 12 lying on only one face of a portion of the cathode current collector 11 is disposed so as to reside within the straight-line part B of the spiral electrode group in the sectional shape of an ellipse and the end 22b of the anode composition layer 22 lying on respective faces of the anode current collector 21 is disposed so as to also reside within the straight-line part B of the spiral electrode group in the sectional shape of an ellipse. The spiral electrode group fabricated as above described is defined as electrode group “x” according to the comparative example.

4. Fabrication of a Lithium Secondary Battery

Subsequently, the electrode groups “a”, “x”, fabricated as above described are inserted into square-shaped outer cases made of metal (not shown), respectively, and after a current collector tab extending from the respective current collectors is welded to their respective terminals, the junction between the respective square-shaped outer cases made of metal and the sealing plate or the vicinity of the junction is irradiated with laser beams, thereby laser welding both metal cases and the sealing plate. After laser welding, a nonaqueous electrolytic solution is injected into the respective outer cases from a through-hole of the sealing plate before affixing a battery cap on the caulked top of a hollow cap on the sealing plate. By securing the battery cap after injection of the nonaqueous electrolytic solution, lithium secondary batteries A, X are respectively fabricated. The lithium secondary battery using the electrode group “a” is referred to as lithium secondary battery A while the other using the electrode group “x” is referred to as lithium secondary battery X.

Herein, a nonaqueous electrolytic solution prepared by dissolving 1 mol/l of LiPF₆ in a mixed solvent of ethylene carbonate (EC) and diethyl carbonate (DEC) of equal volume proportions is injected as an electrolytic solution. Further, the solute to be dissolved in a solvent may be selected from the group consisting of LiBF₄, LiCF₃SO₃, LiAsF₆, LiN(CF₃SO₂)₂LiC(CF₃SO₂)₃, LiCF₃(CF₂)₃SO₃, etc., besides LiPF₆. In addition, a polymer electrolyte, a gel electrolyte such as a polymer impregnated with a nonaqueous electrolytic solution, a solid electrolyte, and so forth, may also be employed.

Furthermore, as a mixed solvent, an aprotic solvent having no capability of supplying hydrogen ions besides the above-described mixture of ethylene carbonate (EC) and diethyl carbonate (DEC) may be utilized, for example, an organic solvent selected from the group consisting of propylene carbonate (PC), vinylene carbonate (VC), butylene carbonate (BC), γ-butyrolactone (GBL), and so forth, and a mixed solvent consisting of any of the aforementioned organic solvents and any solvent with a low boiling point, selected from the group consisting of dimethyl carbonate (DMC), ethyl methyl carbonate (EMC), 1,2-diethoxyethane (DEE), 1,2-dimethoxyethane (DME), ethoxy-methoxy ethane (EME), and so forth.

5. Measurement of Incidence of Internal Short Circuit

After fabrication, the respective battery voltages of batteries A and X were measured and it was determined that an internal short circuit occurred in both batteries having a measured battery voltage of 0V or less, and the incidence thereof was accordingly measured as shown in Table 1 below. The incidences shown in Table 1 are based on measurements made with respect to one lot with the highest incidence of internal short circuits out of 30 lots of the batteries A and X fabricated as above described respectively, one lot representing daily production.

TABLE 1

| Battery | Incidence of Internal |
|---|---|
| Classification | Short Circuit |
| A | 0.4 ppm |
| X | 3 ppm |

As is evident from the results shown in Table 1, in the case of battery X, a lot having an incidence of internal short circuit of as high as 3 ppm was found, while in the case of battery A, a lot having an incidence of internal short circuit of as slow as 0.4 ppm or less was revealed. This is due to the fact that when fabricating the spiral electrode group x in the sectional shape of an ellipse in the case of battery X through compression molding of the spiral electrode group, portions of the separator 30 existing in the straight-line parts of the spiral electrode group in the sectional shape of an ellipse, respectively, are subjected to compression force, resulting in deterioration of insulation resistance. Consequently, as shown in FIG. 2, through the intermediation of the separator 30 in a state of lowered insulation resistance, the end 12b of the cathode composition layer 12 is opposed to the anode plate 20 (the region X in FIG. 2), and the end 22b of the anode composition layer 22 is opposed to the cathode current collector 11 (the region Y in FIG. 2).

Thus, if these opposing spots (in the regions X, Y, in FIG. 2) are disposed so as to reside within the straight-line parts of the electrode group x, respectively, and foreign matter is introduced into the region X or region Y within the respective straight-line parts of the electrode group x, the foreign matter breaks through the separator 30 in a state of lower insulation resistance, resulting in a short circuit on the spot where the portion of the cathode current collector 11 is opposed to the portion of the anode current collector 21, coated with the anode composition 22, (the region X) and on the spot where the portion of the cathode current collector 11 is opposed to the portion of the anode current collector 21 (the region Y). In the case of such an internal short circuit occurring through the intermediation of the current collectors, it is presumed that a large flow of current occurs and heat generation increases, thereby causing thermal damage.

On the other hand, in the case of battery A, when fabricating the spiral electrode group a in the sectional shape of an ellipse by compression molding of the spiral electrode group, and compression molding as applied was such that the end 12a of the cathode composition layer 12 lying on only one face of the cathode current collector 11 is disposed so as to reside within the curvilinear part A of the spiral electrode group a in the sectional shape of an ellipse, and the end 22a of the anode composition layer 22 resting on the respective faces of the anode current collector 21 is disposed so as to also reside within the curvilinear part A of the spiral electrode group a in the sectional shape of an ellipse. Accordingly, even if compression molding is applied, a portion of the separator 30 residing within the curvilinear part A of the spiral electrode group a is subjected to minimal compression force, so that deterioration of insulation resistance does not occur.

Consequently, if the end 12a of the cathode composition layer 12 and the ends 22a of the anode composition layers 22 are disposed within the curvilinear part A of the spiral electrode group a, a short circuit between the cathode current collector 11 and the anode current collector 21 respectively extending from these ends can be prevented through the intermediation of the separator 30. Accordingly, even if foreign matter is introduced into the curvilinear part A of the spiral electrode group a, occurrence of a short circuit or thermal damage can be forestalled because a portion of the separator 30 residing in the curvilinear part A, has excellent insulation resistance.

Notably, since portions of the separator 30 residing in the straight-line parts of the spiral electrode group a in the sectional shape of an ellipse, respectively, have been subjected to compression force upon the application of compression molding leading to deterioration in insulation resistance, the possibility of a short circuit occurring between the cathode composition layer 12 and the anode composition layer 22 if foreign matter is introduced into the straight-line parts may still arise. Nevertheless, since such kind of a short circuit can be distinguished from the short circuit occurring between the current collectors, a large flow of current does not occur, thereby resulting only in a minor short circuit. Thus, occurrence of a fatal short circuit can be avoided except where occurrence may be due to erroneous battery voltage.

Under the embodiment of the invention described above, a configurational example consists of the cathode current collector 11 being disposed in the outermost peripheral part of the spiral electrode group in order to bring the cathode current collector 11 into contact with the inner face of the outer case of the battery (in this case, the outer case doubling as a cathode terminal). However, an alternative configuration consisting of the anode current collector 21 being brought into contact with the inner face of the outer case of the battery may be adopted, in that the spiral electrode group is wound in such manner that one side provided with the anode composition layer 22 of a portion of the anode current collector 21 having the cathode composition layer 22 residing on only one face thereof, confronts the inner side of the spiral electrode group, such that the anode current collector 21 can reside in the outermost peripheral part of the spiral electrode group, and it will suffice for the purpose that the anode current collector 21 is brought into direct contact with the inner face of the outer case of the battery (in this case, the outer case doubling as an anode terminal).

Further, under the embodiment described above, natural graphite may be used as an anode active material. In addition thereto, a carbonaceous material capable of storing and releasing lithium ions such as, for example, an artificial graphite, carbon black, coke, vitreous carbon, carbon fiber, a sintered body thereof, and so forth, may also be employed. Alternatively, lithium metal, a lithium base alloy such as lithium-aluminum alloy, lithium-lead alloy, lithium-tin alloy, etc., or a metal oxide, having a potential more negative than that of a cathode active material, such as SnO₂, SnO, TiO₂, Nb₂O₃, etc., may also be utilized.

Further still, under the embodiment described above, lithium cobaltate (LiCoO₂) may also be used as a cathode active material, however, in place thereof, spinel lithium maganate (LiMn₂O₄), lithium nickelate (LiNiO₂), or a mixture thereof may be employed.

Further yet, under the embodiment described above, the advantageous effect of the invention does not merely extend to a battery with an outer case made of metal but also applies with respect to a lithium second battery having an electrode body wound about inside an outer case made of metal foil with a resin layer laminated thereto, provided that the configuration thereof is constructed in accordance with the invention.

What is claimed is:

1. A lithium secondary battery incorporating an electrode group comprising:
a cathode made up of a cathode current collector coated with a cathode composition; and
an anode made up of an anode current collector coated with an anode composition, disposed in such manner as to oppose the cathode with a separator sandwiched therebetween,
wherein the electrode group is in the sectional shape of an ellipse having a pair of straight-line parts and curvilinear parts, and the cathode and anode, residing in the outermost peripheral part of the spiral electrode group, are disposed such that the respective boundaries between parts of the respective current collectors coated with corresponding compositions and parts of the respective current collectors uncoated with corresponding compositions are disposed so as to reside within the respective curvilinear parts of the electrode group.
